(19) United States
(12) Patent Application Publication
(10) Pub. No.: US 2010/0274933 A1
(43) Pub. Date: Oct. 28, 2010

(54) Method and apparatus for reducing memory size and bandwidth

(75) Inventor: Kuo-Hung Wang, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/616,197

(22) Filed: Nov. 11, 2009

Related U.S. Application Data
(60) Provisional application No. 61/172,307, filed on Apr. 24, 2009.

(51) Int. Cl. G06F 12/02; G06F 1/04; G06F 13/28

(52) U.S. Cl. 710/22; 713/600; 711/154; 711/E12.002

(57) ABSTRACT

A solid state disk drive is provided. The solid state disk drive includes a memory device and a controller. The memory device includes memory cells for storing data bits. The controller is coupled to the memory device, accesses the memory device according to a clock signal, estimates a work load of the memory device, and adjusts a frequency of the clock signal in accordance with the estimated work load.

### CROSS REFERENCE TO RELATED APPLICATIONS

This application claims the benefit of U.S. Provisional Application No. 61/172,307 filed Apr. 24, 2009, and entitled “Method For Switching Access Speeds Of A Silicon Disk And Silicon Disk Drive Utilizing The Same”. The entire contents of which are hereby incorporated by reference.

### BACKGROUND OF THE INVENTION

1. Field of the Invention

The invention relates to a method for controlling an operation frequency of a solid state disk drive.

2. Description of the Related Art

Computer systems store data to different types of storage media and devices. Such storage media and devices may be considered nonvolatile, and persistently store data even when power thereto is turned off. An example of a nonvolatile storage device is a hard disk of a computer system. Storage devices may also include NAND flash memory and solid state disks (SSD). Storage media may include actual discs or platters that are accessed through the storage device. An operating system (OS) may be requested to perform actions, such as read and write to particular locations on a storage medium by a processor.

Simultaneous access of nonvolatile flash by multiple host modules have been developed as nonvolatile flash is now widely used as a mass storage device in many electronic products. Under this condition however, overall power consumption is greatly increased with the increase in the amount of host modules accessing the nonvolatile flash. To improve system performance and further reduce power consumption, a method for controlling operation frequency of a solid state disk drive in accordance with system work load is highly desired.

### BRIEF SUMMARY OF THE INVENTION

A solid state disk drive and a method for controlling an operation frequency of a solid state disk drive are provided. An embodiment of a solid state disk drive comprises a memory device and a controller. The memory device comprises a plurality of memory cells for storing data bits. The controller is coupled to the memory device, accesses the memory device according to a clock signal, estimates a work load of the memory device, and adjusts a frequency of the clock signal in accordance with the estimated work load.

An embodiment of a method for controlling an operation frequency of a solid state disk drive comprises estimating a work load of a memory device according to properties of at least one access operation of the memory device, and adjusting the operation frequency of the solid state disk drive in accordance with the estimated work load, wherein the operation frequency is decreased when the estimated work load of the memory device is lower than a predetermined lower threshold, and the operation frequency is increased when the estimated work load of the memory device exceeds a predetermined upper threshold.

Another embodiment of a solid state disk drive comprises a memory device and a controller. The memory device comprises a plurality of memory cells for storing data bits. The controller is coupled to a host outputting at least one access request to access the memory device and accesses the memory device in response to the at least one access request according to a clock signal. The controller comprises a monitoring unit monitoring the at least one access request, determining whether the at least one access request causes the memory device to have a heavy work load or a light work load, and generating a clock control signal to adjust a frequency of the clock signal according to the determination result.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a solid state disk drive according to an embodiment of the invention;

FIG. 2 shows a solid state disk drive according to another embodiment of the invention;

FIG. 3 shows a flow chart of a method for controlling the operation frequency of a solid state disk drive according to an embodiment of the invention;

FIG. 4 shows a flow chart of a work load estimation method according to an embodiment of the invention;

FIG. 5 shows a flow chart of a work load estimation method according to another embodiment of the invention;

FIG. 6 shows a flow chart of a work load estimation method according to another embodiment of the invention;

FIG. 7 shows a flow chart of a work load estimation method according to another embodiment of the invention;

FIG. 8 shows a flow chart of a work load estimation method according to another embodiment of the invention; and

FIG. 9 shows a flow chart of a work load estimation method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

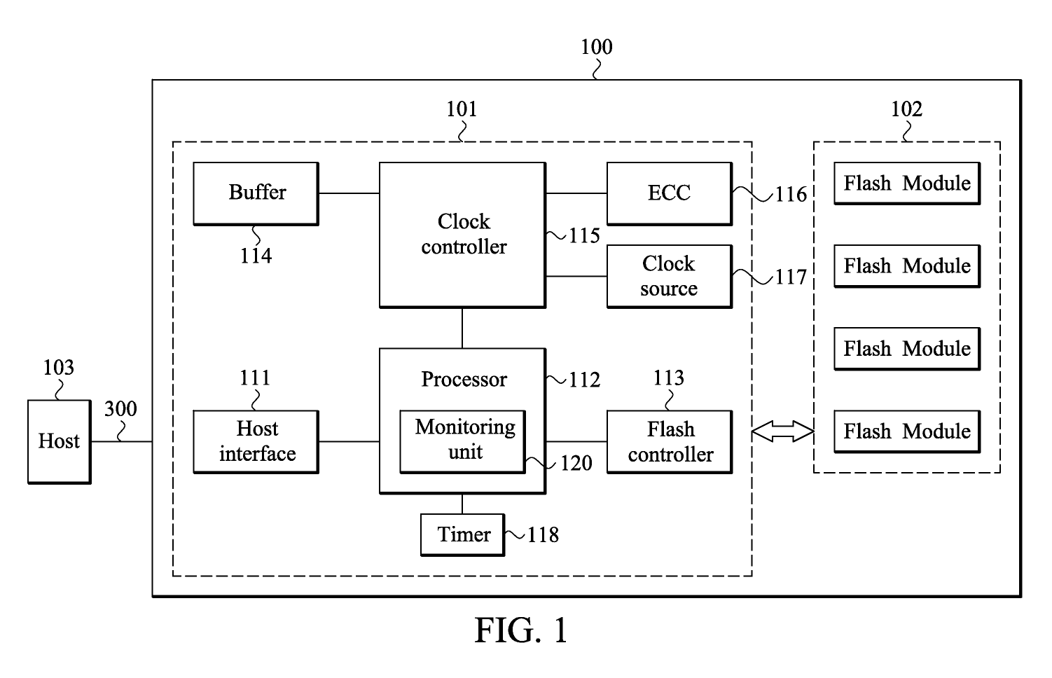

FIG. 1 shows a solid state disk (SSD) drive according to an embodiment of the invention. The SSD drive 100 comprises a controller 101 and a memory device 102. The memory device 102 comprises a plurality of memory cells for storing data bits. According to an embodiment of the invention, the memory device 102 may be a nonvolatile storage device, such as a solid state disk (SSD) memory. The controller 101 is coupled to the memory device 102 for managing the memory device 102. According to an embodiment of the invention, the controller 101 accesses the memory device 102 according to a clock signal, estimates a work load of the memory device 102, and adjusts a frequency of the clock signal in accordance with the estimated work load.

The controller 101 comprises a host interface 111, a processor 112, a flash controller 113, a buffer 114, a clock controller 115, an Error Checking and Correcting (ECC) engine 116, a clock source 117 and a timer 118, wherein the timer 18 can be implemented by a Real Time Clock (RTC) in some embodiments. The host interface 111 interfaces the SSD drive 100 to a host 103. In general, a host is defined as a system or subsystem that stores information in the memory device 102. The host interface 111 receives access requests (for example, read and write requests) from the host 103. The processor 112 is coupled to the host interface 111, receives the access requests from the host interface 111 and generates corresponding access commands to control the access operations of the memory device 102. The ECC engine 116 provides error checking and correcting for the data stored in the memory device 102. The buffer 114 may be any kind of memory device to buffer data, for example, a dynamic random access memory (DRAM). The clock controller 115 receives an oscillating signal from the clock source 117, and generates the clock signal(s) for the modules in the controller 101. It is noted that the clock source 117 may be any kind of oscillator or clock generating source and the clock signal(s) may have different frequencies for different modules. Therefore, the invention should not be limited thereto. The host interface 111, the processor 112, the flash controller 113, the buffer 114, and the ECC engine 116 operate according to the clock signal(s).

According to an embodiment of the invention, the controller 101 may further comprise a monitoring unit 120. The monitoring unit 120 monitors the access requests and the access commands of the memory device 102, determines properties of the access requests and access commands to estimate the work load of the memory device 102, and generates a clock control signal to adjust the frequency of the clock signal according to the estimated work load. For example, the monitoring unit 120 may determine whether the access requests and access commands would cause the memory device 102 to have a heavy work load or a light work load, and generates the clock control signal according to the determination result to adjust the frequency of the clock signal. It is noted that the clock control signal may also be generated by the processor 112 according to the estimated work load and the invention should not be limited thereto. The clock controller 115 generates the clock signal according to the clock control signal so as to increase or decrease the clock frequency in accordance with the estimated work load. When the memory device 102 is determined to have a heavy work load, the clock frequency may be increased so as to quickly respond to the access requests. When the memory device 102 is determined to have a light work load, the clock frequency may be decreased so as to save power.

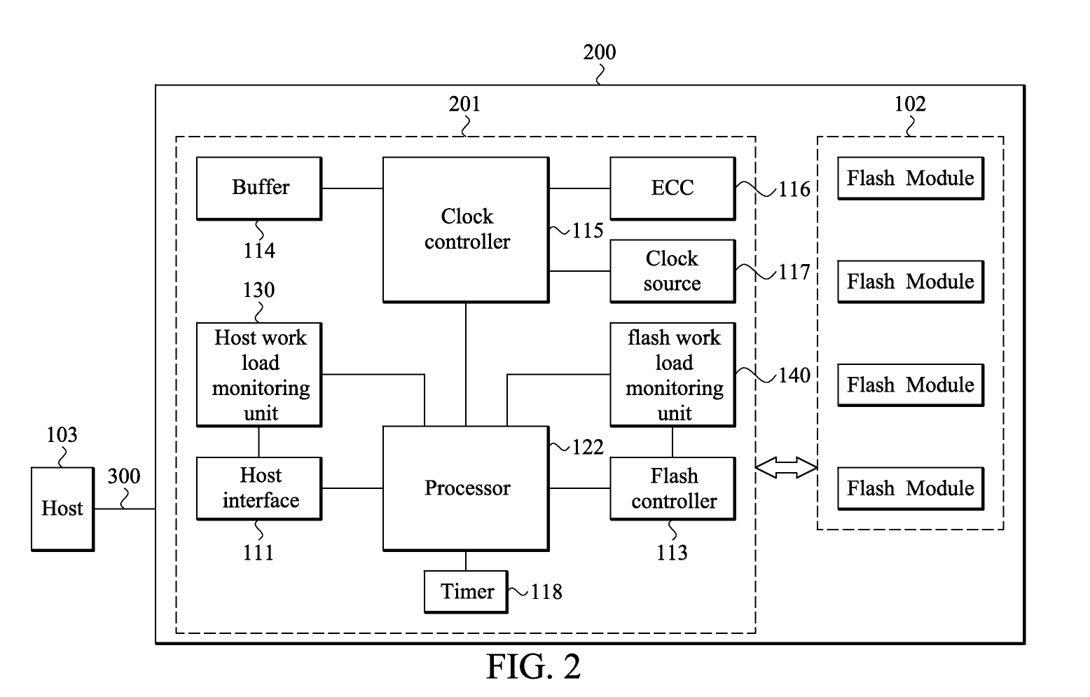

According to an embodiment of the invention, the monitoring unit 120 may be implemented in software, firmware, hardware or any combination thereof. For different embodiments of the invention, the monitoring unit 120 may also be arranged outside of the processor 112. FIG. 2 shows a solid state disk drive 200 according to another embodiment of the invention. Details of the controller 201 will be omitted here for the sake of brevity, as reference may be made to the prior descriptions for the controller 101 of FIG. 1. According to the embodiment of the invention, the controller 201 comprises a host work load monitoring unit 130 and a flash work load monitoring unit 140. The host work load monitoring unit 130 is coupled to the host interface 111 to monitor the jobs assigned by the host 103 and estimate the work load of the memory device 102, accordingly. The flash work load monitoring unit 140 is coupled to the flash controller 113 to monitor the operation of the memory device 102 and estimate the work load, accordingly. In the embodiments of the invention, either the host work load monitoring unit 130 or the flash work load monitoring unit 140 may generate the clock control signal to adjust the frequency of the clock signal according to the estimated work load. However, it is noted that the clock control signal may also be generated by the processor 122 according to the estimated work load, and thus the invention should not be limited thereto. According to an embodiment of the invention, the host work load monitoring unit 130 and the flash work load monitoring unit 140 may also be implemented in software, firmware, hardware or any combination thereof.

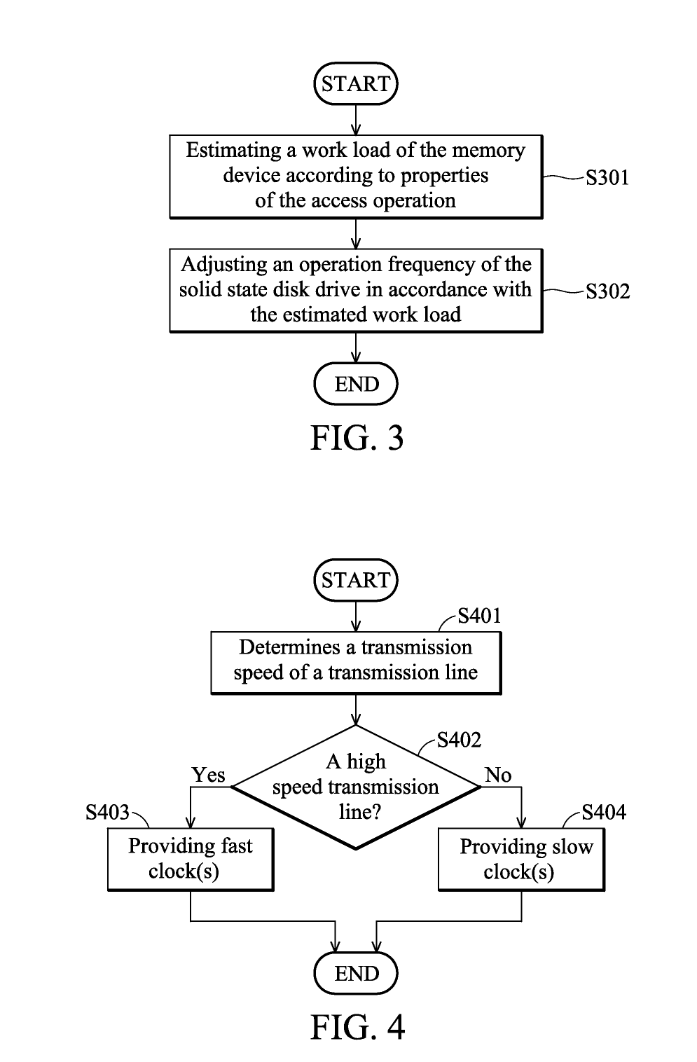

FIG. 3 shows a flow chart of a method for controlling the operation frequency of an SSD drive according to an embodiment of the invention. When receiving at least one access command corresponding to the access operation(s), the monitoring unit 120 (or the host work load monitoring unit 130 and/or the flash work load monitoring unit 140) estimates a work load of the memory device according to properties of the access operation(s) (Step S301). According to the embodiment of the invention, the properties of the access operation(s) may be estimated according to the access request from the host 103 or the access command to the memory device 102. Embodiments of work load estimation methods will be described in greater detail in the following section. After work load estimation, the operation frequency of the SSD drive may be adjusted in accordance with the estimated work load (Step S302). By adaptively adjusting the operation frequency of the SSD drive, different accessing speeds for accessing the memory device may be provided to access the memory device more efficiently.

According to the embodiment of the invention, when the estimated work load is lower than a predetermined lower threshold, the memory device 102 is determined to have a light work load and the operation frequencies of the modules in the controller 101 and/or the controller 201 may be decreased so as to save power consumption. In the embodiments of the invention, the clock controller 115 may decrease the frequency of the clock signal according to the clock control signal so as to decrease the operation frequencies of the processor 112, the flash controller 113, the buffer 114, and/or the ECC engine 116. On the other hand, when the estimated work load of the memory device exceeds a predetermined upper threshold, the memory device 102 is determined to have a heavy work load and the operation frequencies of the modules in the controller 101 and/or the controller 201 may be increased for the controller 101 so as to respond to the access requests faster. In the embodiments of the invention, the clock controller 115 may increase the frequency of the clock signal according to the clock control signal so as to increase the operation frequencies of the processor 112, the flash controller 113, the buffer 114, and/or the ECC engine 116.

FIG. 4 shows a flow chart of a work load estimation method according to an embodiment of the invention. According to the embodiment of the invention, after receiving an access command and/or request, the monitoring unit 120 or the host work load monitoring unit 130 determines a transmission speed of a transmission line (such as the transmission line 300 as shown in FIG. 1) coupled between the host 103 and the controller 101, and estimates the work load according to the transmission speed. According to the embodiment of the invention, the transmission line 300 may be a Serial Advanced Technology Attachment (SATA) transmission line. The host interface 111 may obtain information about the transmission speed of the transmission line 300 by a handshake procedure with the host 103, and thus, the monitoring unit 120 or the host work load monitoring unit 130 may obtain the information therefrom.

When the transmission line is determined with a higher transmission speed (as an example, for SATA 3 Gbit/s or higher) (Step S402), the monitoring unit 120 or the host work load monitoring unit 130 may determine that the corresponding access requests from the host may cause the memory device 102 to have a heavy work load. Thus, the monitoring unit 120 or the host work load monitoring unit 130 may determine to provide fast clock(s) for the modules in the controller 101 or the controller 201 (Step S403). According to the embodiment of the invention, when necessary, the monitoring unit 120 or the host work load monitoring unit 130 may generate the clock control signal to increase the clock frequency. On the other hand, when the transmission line is determined to be operating at a lower transmission speed (as an example, for SATA 1.5 Gbit/s) in Step S402, the monitoring unit 120 or the host work load monitoring unit 130 may determine that the corresponding access requests from the host may not cause the memory device 102 to have a heavy work load. Thus, the monitoring unit 120 or the host work load monitoring unit 130 may determine to provide slow clock(s) for the modules in the controller 101 or the controller 201 (Step S404). According to the embodiment of the invention, when necessary, the monitoring unit 120 or the host work load monitoring unit 130 may generate the clock control signal to decrease the clock frequency.

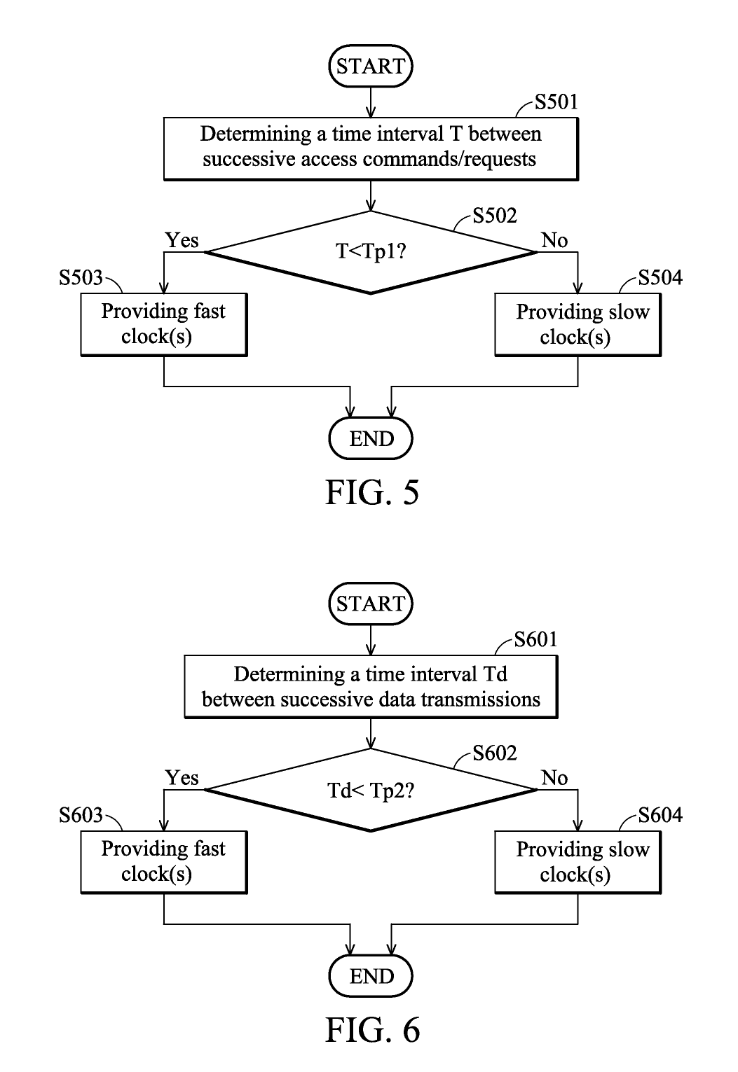

FIG. 5 shows a flow chart of a work load estimation method according to another embodiment of the invention. According to the embodiment of the invention, after receiving an access command and/or request, the monitoring unit 120 or the host work load monitoring unit 130 determines a time interval between successive access commands/requests (Step S501) and estimates the work load according to a length of the time interval. The monitoring unit 120 or the host work load monitoring unit 130 may estimate the time interval according to the beginning time and the end time of the successive access commands/requests. As an example, the monitoring unit 120 or the host work load monitoring unit 130 may record the time Te at the end of a previous command and/or request, and the time Ts at the beginning of a current command and/or request according to the timer 118. The monitoring unit 120 or the host work load monitoring unit 130 may further determine whether the time interval T=(Ts−Te) is less than an expected command period Tp1 (Step S502).

When (T<Tp1), the monitoring unit 120 or the host work load monitoring unit 130 may determine that the frequently generated access commands/requests may cause the memory device 102 to have a heavy work load. Thus, the monitoring unit 120 or the host work load monitoring unit 130 may determine to provide fast clock(s) for the modules in the controller 101 or the controller 201 (Step S503). According to the embodiment of the invention, when necessary, the monitoring unit 120 or the host work load monitoring unit 130 may generate the clock control signal to increase the clock frequency. On the other hand, when (T>=Tp1), the monitoring unit 120 or the host work load monitoring unit 130 may determine that the access commands/requests may not cause the memory device 102 to have a heavy work load. Thus, the monitoring unit 120 or the host work load monitoring unit 130 may determine to provide slow clock(s) for the modules in the controller 101 or the controller 201 (Step S504). According to the embodiment of the invention, when necessary, the monitoring unit 120 or the host work load monitoring unit 130 may generate the clock control signal to decrease the clock frequency.

FIG. 6 shows a flow chart of a work load estimation method according to another embodiment of the invention. According to the embodiment of the invention, after receiving an access command and/or request, the monitoring unit 120 or the host work load monitoring unit 130 determines a time interval Td between successive data transmissions (Step S601) and determines whether the time interval Td is less than an expected data transmission period Tp2 (Step S602) to estimate the work load according to a length of the time interval. When (Td<Tp2), the monitoring unit 120 or the host work load monitoring unit 130 may determine that corresponding access commands and/or requests may cause the memory device 102 to have a heavy work load. Thus, the monitoring unit 120 or the host work load monitoring unit 130 may determine to provide fast clock(s) for the modules in the controller 101 or the controller 201 (Step S603). According to the embodiment of the invention, when necessary, the monitoring unit 120 or the host work load monitoring unit 130 may generate the clock control signal to increase the clock frequency. On the other hand, when (Td>=Tp2), the monitoring unit 120 or the host work load monitoring unit 130 may determine that the access commands and/or requests may not cause the memory device 102 to have a heavy work load. Thus, the monitoring unit 120 or the host work load monitoring unit 130 may determine to provide slow clock(s) for the modules in the controller 101 or the controller 201 (Step S604). According to the embodiment of the invention, when necessary, the monitoring unit 120 or the host work load monitoring unit 130 may generate the clock control signal to decrease the clock frequency.

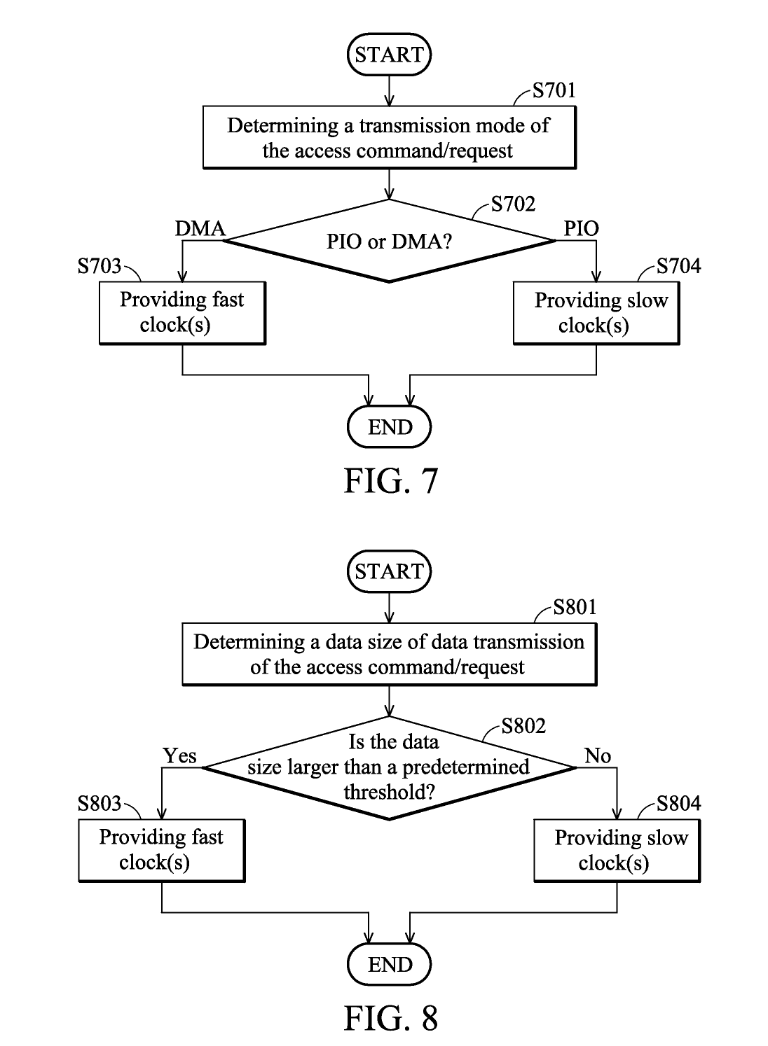

FIG. 7 shows a flow chart of a work load estimation method according to another embodiment of the invention. According to the embodiment of the invention, after receiving an access command and/or request, the monitoring unit 120 or the host work load monitoring unit 130 determines a transmission mode of the access command/request (Step S701), and estimates the work load according to the transmission mode. According to an embodiment, the monitoring unit 120 or the host work load monitoring unit 130 may determine whether the transmission mode is a Programmed input/output (PIO) mode or a Direct Memory Access (DMA) mode (Step S702).

Direct memory access (DMA) is a feature of modern computers and microprocessors that allows certain hardware subsystems within the host to access memory device for reading and/or writing independently of the central processing unit (such as the processors 112 and 122). Therefore, DMA is a technique suitable for quickly transferring mass amount of data without interrupting the current system process. According to the embodiment of invention, when the transmission mode is a DMA, the monitoring unit 120 or the host work load monitoring unit 130 may determine that the access command/request may cause the memory device 102 to have a heavy work load. Thus, the monitoring unit 120 or the host work load monitoring unit 130 may determine to provide fast clock(s) for the modules in the controller 101 or the controller 201 (Step S703). According to the embodiment of the invention, when necessary, the monitoring unit 120 or the host work load monitoring unit 130 may generate the clock control signal to increase the clock frequency. On the other hand, Programmed input/output (PIO) is a feature of transferring data between the (such as the processors 112 and 122) and a peripheral such as the memory device. Therefore, the transmission speed of PIO is slower than that of DMA. When the transmission mode is a PIO, the monitoring unit 120 or the host work load monitoring unit 130 may determine that the access command/request may not cause the memory device 102 to have a heavy work load. Thus, the monitoring unit 120 or the host work load monitoring unit 130 may determine to provide slow clock(s) for the modules in the controller 101 or the controller 201 (Step S704). According to the embodiment of the invention, when necessary, the monitoring unit 120 or the host work load monitoring unit 130 may generate the clock control signal to decrease the clock frequency.

FIG. 8 shows a flow chart of a work load estimation method according to another embodiment of the invention. According to the embodiment of the invention, after receiving an access command and/or request, the monitoring unit 120 or the host work load monitoring unit 130 determines a data size of data transmission of the access command/request (Step S801) and determines whether the data size is larger than a predetermined threshold (Step S802) to estimate the work load according to the data size. When the data size is larger than the predetermined threshold, the monitoring unit 120 or the host work load monitoring unit 130 may determine that the access command/request may cause the memory device 102 to have a heavy work load. Thus, the monitoring unit 120 or the host work load monitoring unit 130 may determine to provide fast clock(s) for the modules in the controller 101 or the controller 201 (Step S803). According to the embodiment of the invention, when necessary, the monitoring unit 120 or the host work load monitoring unit 130 may generate the clock control signal to increase the clock frequency. On the other hand, when the data size is not larger than the predetermined threshold, the monitoring unit 120 or the host work load monitoring unit 130 may determine that the access command and/or request may not cause the memory device 102 to have a heavy work load. Thus, the monitoring unit 120 or the host work load monitoring unit 130 may determine to provide slow clock(s) for the modules in the controller 101 or the controller 201 (Step S804). According to the embodiment of the invention, when necessary, the monitoring unit 120 or the host work load monitoring unit 130 may generate the clock control signal to decrease the clock frequency.

According to another embodiment of the invention, the monitoring unit 120 or the host work load monitoring unit 130 may also estimate the work load according to an indication signal output by an application program of the host 103. The application program may be a software or firmware program to monitor the transmission speed requirement of the access request of the host 103, and inform the controller 101 or 102 in advance so as to adjust the clock frequency according to the transmission speed requirement.

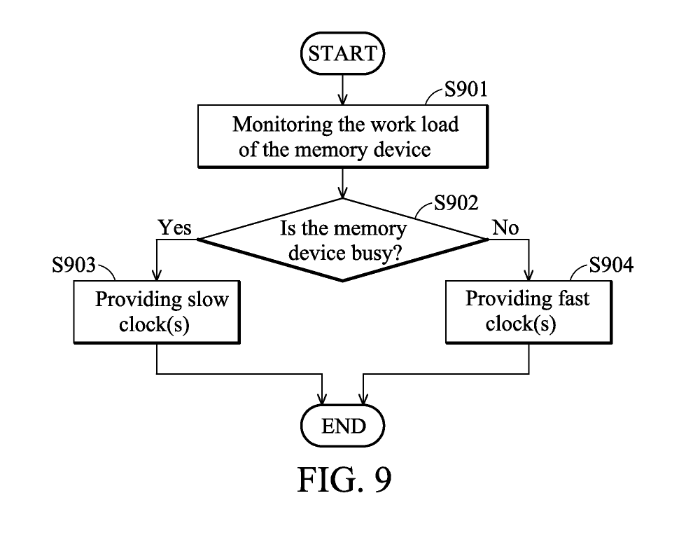

FIG. 9 shows a flow chart of a work load estimation method according to another embodiment of the invention. According to the embodiment of the invention, the monitoring unit 120 or the flash work load monitoring unit 140 may monitor the work load of the memory device 102 (Step S901) and determine whether the memory device 102 has entered a busy state (Step S902). The monitoring unit 120 or the flash work load monitoring unit 140 may determine whether the memory device 102 is busy according the received access commands. For example, the memory device 102 may be determined to have entered the busy state when being programmed. In the busy state, the memory device 102 may not be able to respond to access commands in time. Thus, the monitoring unit 120 or the flash work load monitoring unit 140 may determine to provide slow clock(s) for the modules in the controller 101 or the controller 201 (Step S903). According to the embodiment of the invention, when necessary, the monitoring unit 120 or the flash work load monitoring unit 140 may generate the clock control signal to decrease the clock frequency. According to another embodiment of the invention, some modules may also be turned off (for example, by adjusting the operation frequencies of the modules to zero) so as to further save the power consumption. As an example, when the memory device 102 is determined to have entered the busy state, the operation frequencies of flash controller 113, the buffer 114 and the ECC engine 116 may be decreased to provide a slow clock service, or even set to zero to save power. On the other hand, when the memory device is determined not be in the busy state, the monitoring unit 120 or the flash work load monitoring unit 140 may determine to provide fast clock(s) for the modules in the controller 101 or the controller 201 (Step S904). According to the embodiment of the invention, when necessary, the monitoring unit 120 or the flash work load monitoring unit 140 may generate the clock control signal to increase the clock frequency.

According to the embodiments of the invention, by adaptively adjusting the speed of the clocks (slow clock or fast clock) according to different work loads, power efficiency is maximized as unnecessary power consumption is prevented. In addition, access speeds may be further increased for heavy work loads to improve functionality of the SSD drive. Therefore, improving overall performance of the SSD drive of the invention when compared to prior art.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A solid state disk drive, comprising:
a memory device, comprising a plurality of memory cells for storing data bits; and
a controller, coupled to the memory device, accessing the memory device according to a clock signal, estimating a work load of the memory device, and adjusting a frequency of the clock signal in accordance with the estimated work load.

2. The solid state disk drive as claimed in claim 1, wherein the controller further decreases the frequency of the clock signal when the estimated work load of the memory device is lower than a predetermined lower threshold, and increases the frequency of the clock signal when the estimated work load of the memory device exceeds a predetermined upper threshold.

3. The solid state disk drive as claimed in claim 1, wherein the controller is coupled to a host outputting at least one access request to access the memory device and comprises:
a clock controller, generating the clock signal according to a clock control signal;
a processor, receiving the at least one access request and generating at least one access command to access the memory device accordingly, wherein the processor operates according to the clock signal; and
a monitoring unit, monitoring the at least one access request and the at least one access command of the memory device, determining properties of the at least one access request and access command to estimate the work load, and generating the clock control signal to adjust the frequency of the clock signal according to the estimated work load.

4. The solid state disk drive as claimed in claim 3, wherein the monitoring unit further determines a transmission speed of a transmission line coupled between the host and the controller, and estimates the work load according to the transmission speed.

5. The solid state disk drive as claimed in claim 3, wherein the monitoring unit further determines a time interval between successive access requests, and estimates the work load according to a length of the time interval.

6. The solid state disk drive as claimed in claim 3, wherein the monitoring unit further estimates a time interval between successive data transmissions of the memory device, and estimates the work load according to a length of the time interval.

7. The solid state disk drive as claimed in claim 3, wherein the monitoring unit further determines a transmission mode of the at least one access request, and estimates the work load according to the transmission mode.

8. The solid state disk drive as claimed in claim 7, wherein when the transmission mode is determined as a Programmed input/output (PIO) mode, the monitoring unit generates the clock control signal to decrease the frequency of the clock signal.

9. The solid state disk drive as claimed in claim 7, wherein when the transmission mode is determined as a Direct Memory Access (DMA) mode, the monitoring unit generates the clock control signal to increase the frequency of the clock signal.

10. The solid state disk drive as claimed in claim 3, wherein the monitoring unit further estimates a data size of data transmission of the at least one access request and/or the at least one access command, and estimates the work load according to the data size.

11. The solid state disk drive as claimed in claim 3, wherein the monitoring unit further receives an indication signal from the host when the host outputs the access request, and generates the clock control signal to adjust the frequency of the clock signal according to the indication signal, and the indication signal is generated by the host to indicate a transmission speed requirement corresponding to the access request.

12. The solid state disk drive as claimed in claim 3, wherein the monitoring unit further determines whether the memory device is busy according to the estimated work load, and generates the clock control signal to decrease the frequency of the clock signal when the memory device is determined to be busy.

13. A method for controlling an operation frequency of a solid state disk drive comprising:
estimating a work load of a memory device according to property of at least one access operation of the memory device; and
adjusting the operation frequency of the solid state disk drive in accordance with the estimated work load, wherein the operation frequency is decreased when the estimated work load of the memory device is lower than a predetermined lower threshold, and the operation frequency is increased when the estimated work load of the memory device exceeds a predetermined upper threshold.

14. The method as claimed in claim 13, further comprising:
determining whether the memory device is busy according to the estimated work load; and
decreasing the operation frequency when the memory device is determined to be busy.

15. The method as claimed in claim 13, further comprising:
determining a transmission speed of a transmission line coupled between a host and the solid state disk drive; and
estimating the work load according to the transmission speed.

16. The method as claimed in claim 13, further comprising:
determining a time interval between successive access requests of the memory device; and
estimating the work load according to a length of the time interval.

17. The method as claimed in claim 13, further comprising:
estimating a time interval between successive data transmissions of the memory device; and
estimating the work load according to a length of the time interval.

18. The method as claimed in claim 13, further comprising:
determining a transmission mode of the at least one access request of the memory device; and
estimating the work load according to the transmission mode.

19. The method as claimed in claim 13, further comprising:
estimating a data size of data transmission of the access operation; and
estimating the work load according to the data size.

20. The method as claimed in claim 13, further comprising:
receiving an indication signal corresponding to an access request from the host, wherein the indication signal indicates a transmission speed requirement corresponding to the access request; and
adjusting the operation frequency according to the indication signal.

21. A solid state disk drive, comprising:
a memory device, comprising a plurality of memory cells for storing data bits; and
a controller, coupled to a host, outputting at least one access request to access the memory device according to a clock signal, wherein the controller comprises:
a monitoring unit, monitoring the at least one access request, determining whether the at least one access request causes the memory device to have a heavy work load or a light work load, and generating a clock control signal to adjust a frequency of the clock signal according to the determination result.

22. The solid state disk drive as claimed in claim 21, wherein the monitoring unit generates the clock control signal to decrease the frequency of the clock signal when the memory device is determined to have a light work load, and generates the clock control signal to increase the frequency of the clock signal when the memory device is determined to have a heavy work load.

23. The solid state disk drive as claimed in claim 21, wherein the monitoring unit further determines a time interval between successive access requests, and determines whether the successive access requests cause the memory device to have a heavy work load or a light work load according to a length of the time interval.

24. The solid state disk drive as claimed in claim 21, wherein the monitoring unit further determines a time interval between successive data transmissions of the memory device, and determines whether the successive data transmissions cause the memory device to have a heavy work load or a light work load according to a length of the time interval.

25. The solid state disk drive as claimed in claim 21, wherein the monitoring unit further determines a transmission speed of a transmission line coupled between the host and the controller, and determines whether the at least one access request causes the memory device to have a heavy work load or a light work load according to the transmission speed.
